(19) United States
(12) Patent Application Publication
(10) Pub. No.: US 2021/0104156 A1
(43) Pub. Date: Apr. 8, 2021

(54) METHOD AND DEVICE FOR RECORDING A TRAFFIC SITUATION WHEN A VEHICLE DRIVES PAST A RECORDING DEVICE

(71) Applicant: JENOPTIK Robot GmbH, Monheim (DE)

(72) Inventor: Michael TRUMMER, Hildesheim (DE)

(73) Assignee: JENOPTIK Robot GmbH, Monheim (DE)

(21) Appl. No.: 17/062,246

(22) Filed: Oct. 2, 2020

(30) Foreign Application Priority Data
Oct. 2, 2019 (DE) 10 2019 126 562.2

(51) Int. Cl. G08G 1/054; G06K 9/00; H04N 5/272; H04N 5/232

(52) U.S. Cl. CPC G08G 1/054; H04N 5/23299; H04N 5/272; G06K 9/00785

(57) ABSTRACT

A method for recording a traffic situation when a vehicle drives past a recording device, the method includes reading in a first image which depicts the vehicle at a first point in time at a first position in an area surrounding the recording device and a second image which depicts the vehicle at a second point in time at a second position in the area surrounding the recording device. In addition, a step of sensing a speed of the vehicle at the first and/or second point in time and/or in a time interval between the first and/or second point in time is provided. Also provided is a step of storing the first image and the second image, the first and second points in time and/or a time period between the first and second points in time, as well as the speed of the vehicle as a traffic situation data set.

This nonprovisional application claims priority under 35 U.S.C. § 119(a) to German Patent Application No. 10 2019 126 562.2, which was filed in Germany on Oct. 2, 2019, and which is herein incorporated by reference.

### BACKGROUND OF THE INVENTION

### Field of the Invention

The present invention relates to a method and a device for recording a traffic situation when a vehicle drives past a recording device.

### Description of the Background Art

In conventional recording devices for monitoring a traffic situation, specifically for monitoring occurrences of speeding in road traffic, a current speed of a vehicle is often sensed by means of a radar beam or a laser beam, and if this speed is higher than a locally permissible maximum speed, a photograph of the vehicle (advantageously together with the driver) is captured in order to document this incidence of speeding in a legally valid fashion. For this purpose, the speed which is sensed by the recording device is included in this photograph so that a body which penalizes speeding can issue a penalty notice or can implement a corresponding punishment. However, a problematic scenario can arise in which a person who has committed speeding refuses to accept the speed which has been sensed by the recording device and included in the photograph and wishes to verify it. Although the recording devices which are used to monitor incidences of speeding in road traffic are certified by certification authorities such as the Physikalisch-Technische Bundesanstalt (Federal Physical-Technical Institute) in the Federal Republic of Germany and calibrated by corresponding calibration authorities, such independent testing of the monitoring of recording devices used for monitoring instances of speeding is not sufficient for many drivers or even judges. For this reason, there is a need to generate a traffic situation data set when an incidence of speeding by a vehicle is detected, said data set containing not only the speed which is sensed with very precise physical methods such as measurement by radar, lidar or laser, but also information which makes it easier for a driver who is accused of speeding or a judge to check the plausibility of the actual speed.

DE 10 2012 219 220 A1 describes a method which makes an estimate of the speed by capturing two images with a camera of a vehicle driving past at different points in time, by measuring lengths or widths or distances between points which lie on the contour of the vehicle.

WO 2010 7 043 252 A1 describes a method for determining speed by means of at least two images and computer process optimization so that for the determination of the calculation value of the speed only part of the image information contained in the first image and the entire image information contained in the second image is read out. Therefore, a depiction of the same vehicle is produced in precisely one image, wherein in a partial depiction only part of the vehicle is depicted. In addition, it is proposed to determine a reference length by means of characteristic dimensions.

KR 10 2008 0 087 618 A describes a method which also serves to determine a speed by means of a plurality of photographs with the aid of the front and rear vehicle edges and a vehicle length which is determined therefrom and is included in the speed calculation.

DE 43 30 349 A1 describes a method for determining the speed of vehicles, wherein the presence of the vehicle at at least two locations which lie one after the other in the direction of travel is determined and the speed is calculated over the distance and the time so that at least part of the vehicle contour is sensed at at least two measurement points which lie one after the other at a predefined distance.

KR 10 2005 0 048 961 A describes a method for determining the speeds of vehicles which pass a sensing unit, wherein the speed of the passing vehicles is measured by a measuring device, and in the event of the display of the speed of a vehicle exceeding a specific maximum speed an imaging processing device is made to capture a first image with a certain delay, and to capture a second image of the vehicle using a digital image sensor, in order to calculate a calculated value from these two images, and wherein the reading off and the calculated value are taken into account in the determination of the speed by the sensor unit, wherein the delay is specified in accordance with the reading off of the speed.

### SUMMARY OF THE INVENTION

It is therefore an object of the present invention to provide a method for recording a traffic situation when a vehicle is driving past a recording device.

In an exemplary embodiment, a method provides the steps of: reading in at least one first image which depicts the vehicle at a first point in time at a first position in an area surrounding the recording device and a second image which depicts the vehicle at a second point in time at a second position in the area surrounding the recording device; sensing a speed of the vehicle at the first and/or second point in time and/or in a time interval between the first and/or second point in time; and storing the first image and the second image, the first and second points in time and/or a time period between the first and second points in time, as well as the speed of the vehicle as a traffic situation data set in order to record the traffic situation, wherein the first and second points in time and/or the time period between the first and second points in time are then added to the traffic situation data set, if the second image has not been captured at a second point in time which lies after a predefined time period between the first and second points in time; and wherein in the storage step the first image and the second image are stored superimposed on one another in such a way that in the traffic situation data set a single superimposition image is generated in which the vehicle is depicted located at the first position at the first point in time and at the second position at the second point in time, and a model type of the vehicle is determined and is stored in the traffic situation data set, wherein the model type is determined using a vehicle database.

The first and second images can be here an image which has been captured by means of a digital camera. In this context, a vehicle, for example a passenger car, a truck, a motorcycle, a bus or the like is depicted in the respective image at a specific position in an area surrounding the recording device. This area surrounding the recording device can be, for example, a section of road in which compliance with the maximum permissible speed by the vehicles driving on this section of road is to be monitored. The first and second images are respectively captured here at the first and second points in time. In this context, the first point in time can lie, for example, before the second point in time by an amount equal to the predefined time period. However, it is also conceivable for the first and second points in time and/or for a time period between the first and second points in time to be stored in the traffic situation data set if the second image has not been captured at a second point in time which lies after a predefined time period between the first and second points in time. In addition, the sensing of a speed of the vehicle is carried out, for example, using a radar beam, a laser beam or the like, wherein a very precise speed measurement of the vehicle is possible by using such a beam. Alternatively or additionally, the speed of the vehicle can, for example, also be sensed passively using the photoelectric barrier principle so that it is not necessary for the recording device to emit electromagnetic waves. Finally, the traffic situation data set is generated by combining the first image, the second image and the sensed speed of the vehicle with one another and storing them as a data packet. It is also conceivable, for example, that this traffic situation data set is signed with a corresponding cryptographic key of the recording device, in order also to convince a doubting driver or judge that the data which is contained in each traffic situation data set has actually been acquired and stored by the recording device and linked to the traffic situation data set.

The approach presented here is based on the realization that by storing the first image and the second image together with the sensed speed it is possible to generate a traffic situation data set in which in addition to the physically very precisely determined speed, for example by evaluating actively emitted electromagnetic waves, it can also be graphically displayed to a driver or judge that the vehicle has moved by a specific distance during the predetermined time period so that, for example, in oral proceedings before a court it becomes possible to use a travel measuring tool and a computer to check computationally the speed of the vehicle which is sensed by the recording device. This makes it possible for the speed which has been sensed by the measuring apparatus of the recording device, released by the certification office or the calibration authority, also to be checked by doubting drivers or judges using simple means in the specific case of speeding by a driver of the vehicle.

According to the invention, the first and second images are stored superimposed in such a way that a single superimposition image is generated in the traffic situation data set, in which image the vehicle is depicted located at the first position at the first point in time and at the second position at the second point in time. For example, such storage can be carried out by virtue of the fact that a first digitally captured image and a second digitally captured image are superimposed in a digital fashion and therefore the vehicle is depicted at the respective first and second positions at the respectively applicable first and second points in time on one shared image. In this way, a dynamic impression of movement is produced in a single image, and measurement-technical checking of the distance travelled during the predefined time period becomes easily possible. This can be implemented, for example, by virtue of the fact that the distance between two significant identical components of the vehicle, such as for example wheels, is measured at the different positions and a distance which the vehicle has moved in the predetermined time period is determined therefrom. It is therefore possible to determine a graphically and very easily the distance travelled by the vehicle, and in turn to determine the current speed of the vehicle by using the predetermined time period.

According to another embodiment of the approach presented here (for example in the storage step), in the superimposition image at least one first component of the vehicle from the first image can also be marked, and the first component of the vehicle from the second image can also be marked, in particular wherein in addition at least one second component of the vehicle from the first image and the second component of the vehicle from the second image can be marked. In this way, respectively corresponding components of the vehicle can advantageously be unambiguously identified in the first and second images and unambiguously and easily measured by virtue of the marking.

Furthermore, according to one embodiment of the approach presented here, e.g. in the storage step, the first and/or the second components from the first image can be connected to the first and/or second components from the second image by means of at least one line. In this way, the direction of travel of the vehicle can also very easily also be graphically represented in the superimposition image, so that doubts relating to the measuring accuracy owing to inaccurate orientation of the recording device can be eliminated.

An embodiment of the approach presented here is also advantageous in which e.g. in the storage step, a distance between a position of the vehicle in the area surrounding the recording device in the first image and a position of the vehicle in the area surrounding the recording device in the second image are determined using the position of the first component in the first image and the position of the first components in the second image and/or are determined using the position of the second component in the first image and the position of the second components in the second image in the area surrounding the recording device. Such an embodiment provides the advantage of easy graphic determination of distances between the respectively applicable components in the first and second images, so that the movement of the vehicle can be represented graphically very well on the basis of the position of the vehicle in the superimposition image at the first and second points in time, as result of which the checking of the measured or sensed speed is simplified.

According to a further embodiment of the approach presented here, e.g. in the storage step plausibility checking of the sensed speed with the determined distance between the vehicle at the first position and the at second position can be carried out using the time period, of the first point in time and/or second point in time, wherein a result of the plausibility checking is added to the traffic situation data set. Such plausibility checking provides the advantage of determining the speed of the vehicle, for example on the basis of different physical measuring methods and of therefore detecting fault measurements which have occurred so that the smallest possible number of incorrect penalty notices is produced.

It is also conceivable to implement an embodiment of the approach presented here in which e.g. in the storage step, in the first image and/or the second image, an auxiliary line is added which represents a course of a vehicle component transversely with respect to the direction of travel, in particular wherein the auxiliary line depicts a profile of a bumper of the vehicle. Such an embodiment of the approach proposed here provides the advantage of also being able to graphically represent movement of the vehicle in the surroundings of the recording device by means of the profile of the auxiliary line transversely with respect to the direction of travel so that for a doubting driver or judge the correctness of the data in the traffic situation data set can be made particularly credible.

According to the invention, in the storage step a model type of the vehicle is determined and stored in the traffic situation data set, wherein the model type is determined using a vehicle database. Such an embodiment provides the advantage of also obtaining specific vehicle geometries, for example the wheelbase, on the basis of the determined model type, so that additional information is present for resolving possible unknown variables during the determination of the distance between reference points in the first image, second image or superimposition image. Alternatively or additionally, the model type can be determined on the basis of a contour of the vehicle.

The speed of the vehicle can be particularly precisely sensed if, according to one embodiment of the approach presented here, in the sensing step the speed is sensed using a lidar system, a radar system and/or a camera system as a speed sensor.

In order to cause as few errors as possible during the recording of the traffic events, the first and second images can be read in by a camera, the location and/or viewing direction of which is unchanged when the first and second images are captured. As result, the traffic situation at the first and second positions is depicted in a static fashion, so that, for example, the determination of the distance between the vehicle located in the first and second positions can be significantly simplified.

Alternatively, according to a further embodiment, a camera for capturing the first and second images can be rotated through a predetermined angle after the first image has been captured, before the second image is captured, wherein in the storage step the predetermined angle is stored in the traffic situation data set. It is also conceivable that two cameras are used to capture the first and second images, the viewing direction of said cameras being orientated rotated through the predetermined angle. Such an embodiment provides the advantage of also being able to carry out traffic monitoring with a sufficiently large monitoring area even in tight spatial monitoring areas, wherein corresponding compensation of this rotation should then be carried out with knowledge of the predetermined angle during the determination of the distance between the vehicle in the first position and the vehicle in the second position.

In order to make a particularly accurate image of the traffic event in the area surrounding the recording device, in the reading-in step at least one third image can be read in which depicts the vehicle at a third point in time at a third position in the area surrounding the recording device, wherein in the sensing step a speed of the vehicle is sensed in a timer interval between the first, second and/or third point in time, and wherein in the storage step the third image, the third point in time and/or a time period between the second and the third point in time, are/is added to the traffic situation data set in order to record the traffic situation, wherein the third point in time and/or a time period between the second and the third point in time are/is then added to the traffic situation data set (170) if the third image has not been captured at a third point in time which lies after a predetermined time period between the second and third points in time. Such an embodiment provides the advantage that acquiring and storing the third image provides a further possibility for checking the recorded traffic situation so that, for example, unusable or out of focus capturing of the first or second image can be compensated.

Variants of the method presented here can be implemented, for example, using software or hardware or in a mixed form composed of software and hardware, for example in a control unit.

The approach presented here also provides a recording device which is designed to carry out the steps of a variant of a method presented here, in corresponding apparatuses, and to actuate and implement said steps. This embodiment variant of the invention in the form of a device can also quickly and efficiently achieve the object on which the invention is based.

For this purpose, the device can have at least one computing unit for processing signals or data, at least one storage unit for storing signals or data, at least one interface to a sensor or an actuator for reading in sensor signals from the sensor or for outputting data signals or control signals to the actuator and/or at least one communication interface for reading in or outputting data which are embedded in a communication protocol. The computer unit can be, for example, a signal processor, a microcontroller or the like, wherein the storage unit can be a flash memory, an EEPROM or a magnetic storage unit. The communication interface can be designed to read in or output data in a wireless fashion and/or line-bound fashion, wherein a communication interface which can read in or output line-bound data can read in this data, for example, electrically or optically from a corresponding data transmission line or output it into a corresponding data transmission line.

A device can be understood here to be an electrical device which processes sensor signals and outputs control signals and/or data signals as a function thereof. The device can have an interface which can be embodied by means of hardware and/or software. In the case of a hardware embodiment, the interfaces may be, for example, part of that which is referred to as a system ASIC which includes a wide variety of functions of the device. However, it is also possible for the interfaces to be separate integrated circuits or to be composed at least partially of discrete components. In the case of a software embodiment, the interfaces may be software modules which are present, for example, in a microcontroller alongside other software modules.

A computer program product or computer program with program code which can be stored on a machine-readable carrier or storage medium such as a semiconductor memory, a hard disk memory or an optical memory and is used to carry out, implement and/or actuate the steps of the method according to one of the embodiments described above, in particular when the program product or program is run on a computer or a device, is also advantageous.

Further scope of applicability of the present invention will become apparent from the detailed description given hereinafter. However, it should be understood that the detailed description and specific examples, while indicating preferred embodiments of the invention, are given by way of illustration only, since various changes. Combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of a traffic situation and a block diagram of a recording device for recording this traffic situation in an area surrounding the recording device;

FIG. 2 shows an illustration of a superimposition image such as is generated, for example, as part of the traffic situation data set; and

FIG. 3 shows a flow diagram of a method for recording a traffic situation.

### DETAILED DESCRIPTION

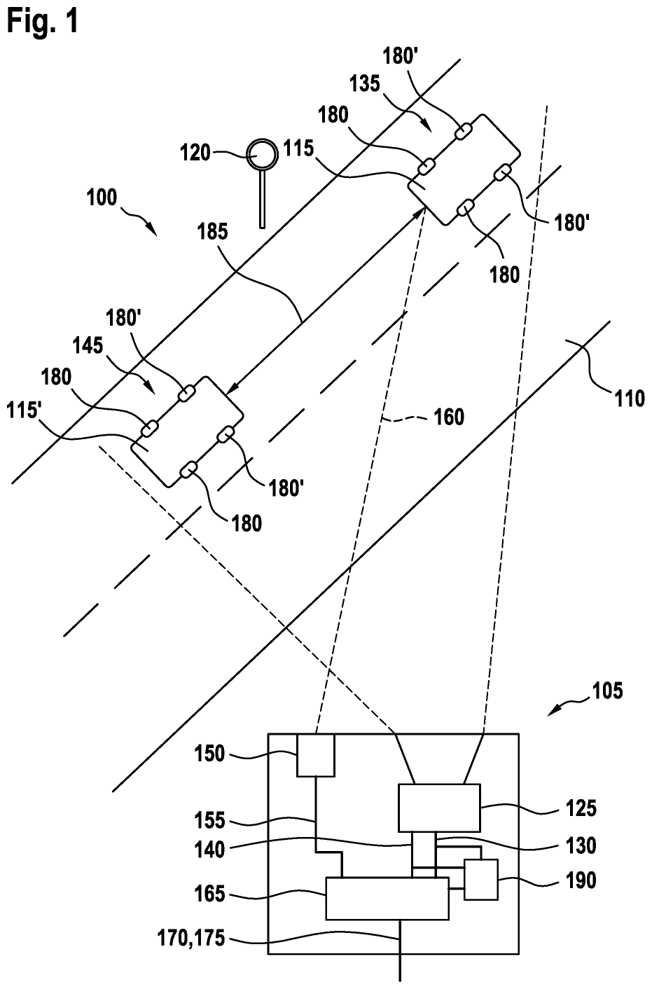

FIG. 1 shows a schematic illustration of a traffic situation 100 and a block diagram of a recording device 105 for recording this traffic situation 100 in an area surrounding the recording device 105. For example a maximum speed, which is indicated by a road sign 120, is permissible on a roadway 110 which represents, for example, a section of road and on which a vehicle 115 is driving. If then, for example, the vehicle 115 drives too fast, the driver of this vehicle 115 inadmissibly commits speeding for which a penalty is to be imposed by a relevant authority or a court. According to the approach presented here, the advantageous recording device 105 is then used to document this instance of speeding as well as possible and to make the actual occurrence of this instance of speeding comprehensible to a driver or a judge. For this purpose, at least one camera 125 which at a first point in time records a first image 130 of the vehicle 115 at a first position 135 and at a second point in time records a second image 140 of the vehicle 115′ at the second position 145 is provided in this recording device 105. The second point in time lies after the first point in time here by a predetermined, known or at least determinable time period, so that a driving speed of the vehicle 115 can be determined using this known time period and a distance which has actually been travelled by the vehicle 115 from the first position 135 to the second position 145. In addition, the recording device 105 comprises a speed sensor 150 in order to sense the speed of the vehicle 115 at the first position 135 (as illustrated in FIG. 1), at the second position 145 or in an area between the first position 135 and the second position 145 and to output a corresponding speed value 155. The speed sensor 150 can sense the speed of the vehicle 115 here by using a radar beam 160 and/or a laser beam. Alternatively or additionally, the speed sensor 150 can also be based on a photoelectric barrier measurement principle or a sensor/sensor system which is mounted in a roadway, wherein this speed sensor can then also be installed, for example, as a sub-component of the recording device 105, set off at the edge of the roadway. A further alternative is to use an optical sensor for a multi-image stereo measurement. The difference here is, in comparison with the proposed method, that different variables (calibration, orientation, object dimension) can be assumed to be known or unknown. The use of such a speed sensor 150 to determine the current speed of the vehicle 115 in comparison with the evaluation from a plurality of images provides the advantage of being able to use physical principles which are very well suited to reliable sensing of the speed of the vehicle 115. A further alternative for determining the speed can be by means of pixel shifting of the captured images even without an additional speed sensor. The image sensor therefore serves as a speed measuring sensor.

In addition, the recording device comprises a storage unit 165 in which the first image 130, the second image 140 and a speed value 155 which represents the speed of the vehicle 115 are linked to form a traffic situation data set 170 and stored. If appropriate, this traffic situation data set 170 can also be provided with an electronic signature which is specific to the recording device 105, in the storage unit 165, in order to be able to reliably verify whether the traffic situation data set 170 has been tampered with after having been read out of the recording device 105. This traffic situation data set 170 may include here a superimposition image 175 in which the first image 130 and the second image 140 are represented in a superimposed fashion so that the vehicle 115 is depicted at the first position 135 and the vehicle 115′ is depicted in the second position 145 in a single image. As a result, a distance which the vehicle 115 has travelled during the predetermined time period can be easily determined graphically in one image, so that as a result the speed of the vehicle 115 can be checked and, for example, the speed which is sensed by the speed sensor 150 and corresponds to the speed value 155 can be verified. The superimposition image 175 can be generated, for example, as a digital superimposition of the second image 140 on the first image 130 if the first image 130 and the second image 140 have been captured by a digital sensor as a camera 125. However, it is also conceivable that when an analogue camera 125 is used which is based, for example, on the use of photochemical film material for the production of the first image 130 and of the second image 140, this film material is exposed twice, at the first point in time and at the second point in time, so that the vehicle 115 is depicted at the first position 135 at the first point in time, and at the second position 145 at the second point in time. In this case, for example the speed value 155 would then be included as a digital display in this superimposition image 175 when at least the first image 130 and/or the second image 140 are/is captured, so that the superimposition 175 which is provided with the speed value 155 can then be understood to be a traffic situation data set 170. Alternatively or additionally, the first and second points in time and/or a time period between the first and second points in time can also be stored in the traffic situation data set 170, in order to be able to determine or extract therefrom the time period between the capturing of the first and second images. It is therefore not necessary for a previously determined time period to be present which indicates how far apart the first and second images have to be/can be captured in chronological terms. The storing of the first and second point in time and/or a time period between the first and the second points in time in the traffic situation data set 170 can also occur, for example, only if in an operating mode of the recording device this time period is not predefined between the capturing of the first image and the capturing of the second image.

Therefore, at least two images are produced of one scene or of the traffic situation 100 through which an object, here the vehicle 115, moves. The time difference as predetermined time period between the captured images is known. The movement of the object or here of the vehicle 115 is assumed to be linear. The position and orientation of the camera 125 are assumed to be constant. It is attempted to reconstruct the speed of the object or of the vehicle 115. No parameters need to be known about the camera 125. The position, viewing direction, focal length and further intrinsic parameters can also remain unknown. For example two features such as the specified components can be identified on the object such as the vehicle here in such a form that these two features are colinear to the direction of movement of the object or vehicle 115. The distance between the two features is known in a way that can be investigated. Here, for example, wheels 180 of the vehicle 115 can serve as components. The distance between these wheels 180 of the vehicle 115 is known at least in an identifiable fashion as the wheelbase through the identification of the model type of the vehicle 115. Deviations from the other assumptions are not to prevent an estimation of the speed. Such a model type of the vehicle 115 can be determined, for example, by virtue of the fact that a database 190 is stored in the recording device 105 (or can be accessed online), and from said database 190 the model/the manufacturer of the vehicle 115 can be determined, for example by utilizing the contours of the vehicle 115 obtained from the first image 130 and/or the second image 140, and in this context the wheelbase can be read out from the technical data stored in the database 190. Such a determined wheelbase can then, for example, also be added to the traffic situation data set 170 in the storage unit 165 and stored, so that this wheelbase can be made directly available during a subsequent evaluation process.

By means of the approach presented here, the distance which is travelled by the object or the vehicle 115 can be reconstructed as the distance 185. Together with the known time difference, the speed of the object or vehicle 115 is reconstructed and can then be also verified graphically from the superimposition image 175 if the speed value 115 is placed in doubt.

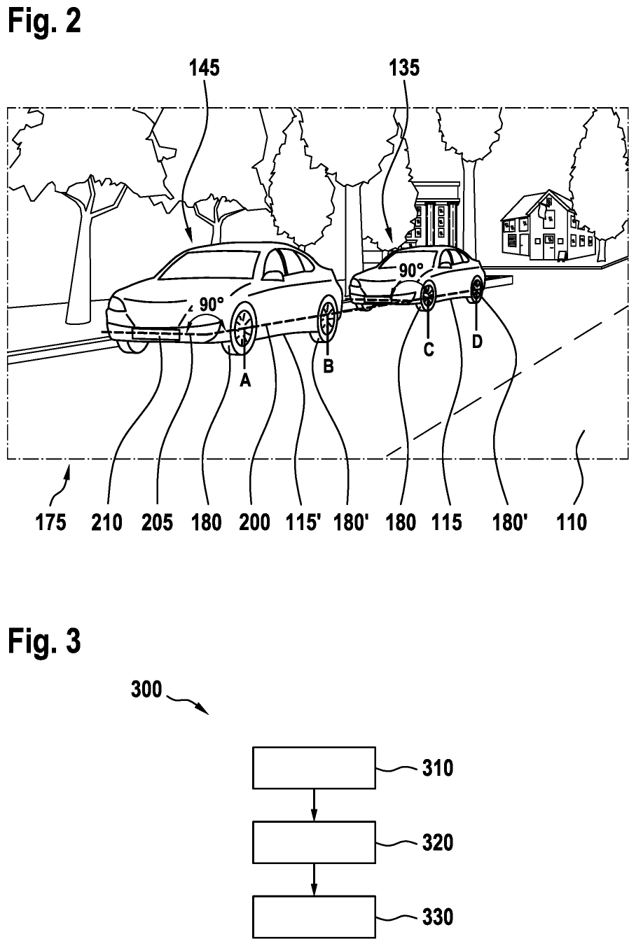

FIG. 2 shows a representation of a superimposition image 175 such as is generated, for example, as part of the traffic situation data set 170. The approach which is presented here uses in this context the invariance of the cross-ratio of a beam bundle intersected by a straight line, such as is known from projective geometry (“cross-ratio of line pencil”). Two successive images, such as the first image 130 and the second image 140, are superimposed. The background advantageously remains constant here. The moving object, here the vehicle 115, at the first position 135 or 115′ at the second position 145, therefore appears at two locations in the combined image (superimposition image) 175. The two particular features, here for example the wheels 180 of the vehicle 115, can then be connected in the combined image by a straight line or line 200 on the basis of the assumptions which are made. Furthermore, four points A, B, C and D in the combined image/superimposition image 175, in each case two composed of the individual images, the first image 130 and the second image 140, are relevant here. These points correspond to the positions of the axle centre points of the wheels 180 of the vehicle 115 in the first position 135 or second position 145. If the distances between the four points A, B, C, D are considered, just one distance is known, the distance BC, as can be inferred from FIG. 2. The distances AB and CD are assumed to be known in a way which can be investigated, for example as the wheelbase of the model type of the vehicle 115.

The cross-ratio can then be calculated with the points A, B, C and D from the combined captured image/the superimposition image 175. The cross-ratio is invariant given the conditions: I=(AC*BD)/(BC*AD).

The cross-ratio applies in the same form to the same points A, B, C, D in global coordinates. The distances AB=CD can be assumed to be known, e.g. as a wheelbase of a vehicle 115. The distance BC is then the only unknown quantity in the formula of the cross-ratio in global coordinates. A quadratic equation is produced which can be solved in the customary way according to the distance BC which is being sought.

The calculated distance BC added to the known distance AB yields the total distance which one of the two features has covered. This is also the distance travelled by the object or vehicle 115 as the distance 185.

In order to use more than two images such as the first image 130 and the second image 140 in the traffic situation data set 170, the speeds are, for example, calculated in pairs based on the respectively used images, utilizing here the previously known time period which has respectively passed between the capturing of the two images which are used.

For vehicles it is therefore possible to develop a method for automatically determining the known dimensions such as the wheelbase with a database connection (for example to the database 190 from FIG. 1) and automatic model recognition. Therefore the speed calculation can also be carried out automatically using the distance between the vehicle 115 at the first position 135 and the vehicle 115′ at the second position 145, as result of which, plausibility checking of the speed determined by the speed sensor 150 is also made possible.

For the manual reconstruction it is also possible to select any desired points on the object or here the vehicle 115 which are colinear to the direction of movement and the distance therebetween which is known in a manner which can be investigated. In particular, the vehicle length constitutes an alternative to the wheelbase, the plausibility of which can be satisfactorily checked.

The approach presented here is very advantageous as a result of the fact that it constitutes a solution which is very easy to implement for speed estimation from two images or even more advantageously from, for example, one double photograph. In this context, there is no need for knowledge about the capturing camera 125. The distances AC, BD, BC and AD are calculated from the pixel coordinates of the images 13 and 140 or of the superimposition image 175. Therefore, the invariant cross-ratio I is known. The wheelbase of vehicle 115 is found here to be, for example, 2.60 m, i.e. the distance AB=CD=2.6. The distance BC can then be calculated, for example, as 6.96 m. In this context, distortions in perspective can also be taken into account, said distortions giving an indication, by virtue of the profile and the gradient of the lines in the superimposition image 175, of the angle at which the camera 125 is oriented with respect to roadway 110 or the direction of travel of the vehicle 115. With the given time difference of the double photograph 0.8 s as the predetermined time period, the speed is obtained, for example, as 43.04 km/h.

The approach presented here itself is intended to essentially thus permit a “visualized estimation” which visualizes the incident in a “quasi-dynamic” fashion to the client, accused drivers and/or the courts; the actual speed measurement should be carried out by using the speed sensor 150 from FIG. 1, since this sensor can evaluate physical parameters which are particularly well suited for speed measurement even if they are only insufficiently suitable for a mechanical evaluation. A particular advantage of the visualization is that the vehicle 115 can be sensed at at least two positions, and the two images (there can also be more than two) are presented in a superimposed fashion as a superimposition image 175 in the same photograph. In this context, geometric lines run in the direction of travel—i.e. there is no need to form geometric relationships, e.g. by measuring the characteristic, which relationships could distract the viewer. Nevertheless, the first image 130 and the second image 140 can also be stored separately, and the distance 185 of the vehicle 115 between the two positions 135 and 145 can be determined, for example, with recourse to the distance of the vehicle 115 in the respective position 135 or 145 from an object in the area surrounding the vehicle 115, for example a tree or a road sign. An auxiliary line 205 can also be inserted into one of the images 130 or 140, which represents a vehicle component 210 of the vehicle 115 such as, for example, the bumper, which is oriented essentially transversely to the direction of travel of the vehicle 115. With this line 200 it is possible to clarify that the travel of the vehicle 115 was as it were linear, since an angular relationship (here for example 90°), e.g. with respect to the edge of the bumper, is then also visualized. The angular relationship is specifically particularly advantageous when it is to be proved that the distance between the first position 135 and the second position 145 is a straight line, since the determination of speed requires the vehicle 115 to have travelled in a straight line between the point in time when the first image 130 is captured and the point in time when the second image 140 is captured.

The approach presented here therefore makes possible a simple and efficient method of so-called second proof. A client-friendly and court-friendly representation of the traffic situation is advantageously generated on just a single image, the superimposition image 175, by multiple exposure/superimposition, wherein this representation is independent of the focal length of the camera 125. In addition, any desired vehicle-specific geometry data items such as vehicle lengths or centre distances can be used, which can be made available, for example, from a database 190 after determination of the model type of the vehicle 115 which is specifically driving past the recording device 105. In this way it is very easily possible to reconstruct the speed from the superimposition image as an AB photograph with e.g. wheelbase data as well as knowledge of the predetermined time period.

FIG. 3 shows a flow diagram of a method 300 for recording a traffic situation when a vehicle is driving past a recording device. The vehicle comprises a step 310 of reading in at least a first image which depicts the vehicle at a first point in time at a first position in an area surrounding the recording device, and a second image which depicts the vehicle at a second point in time at a second position in the area surrounding the recording device. In addition, the method 300 comprises a step 320 of sensing the speed of the vehicle at the first point in time and/or the second point in time and/or in the time interval between the first and/or second points in time. Finally, the method 300 comprises a step 330 of storing the first and second images, the first and second points in time and/or a time period between the first and second points in time, as well as the speed of the vehicle as a traffic situation data set, in order to record the traffic situation, wherein the first and second points in time and/or the time period between the first and the second points in time are then added to the traffic situation data set if the second image has not been captured at a second point in time which lies after a predefined time period between the first and second points in time.

If an exemplary embodiment comprises an “and/or” logic operation between a first feature and a second feature, this is to be understood as meaning that the exemplary embodiment according to one embodiment has both the first feature and the second feature, and according to a further embodiment has either only the first feature or only the second feature.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for recording a traffic situation when a vehicle drives past a recording device, the method comprising:
reading in at least one first image which depicts the vehicle at a first point in time at a first position in an area surrounding the recording device and a second image which depicts the vehicle at a second point in time at a second position in the area surrounding the recording device;
sensing a speed of the vehicle at the first and/or second point in time and/or in a time interval between the first and/or second point in time; and
storing the first image and the second image, the first and second points in time and/or a time period between the first and second points in time, as well as the speed of the vehicle as a traffic situation data set in order to record the traffic situation,
wherein the first and second points in time and/or the time period between the first and second points in time are then added to the traffic situation data set if the second image has not been captured at a second point in time which lies after a predefined time period between the first and second points in time,
wherein the storage step the first image and the second image are stored superimposed on one another in such a way that in the traffic situation data set a single superimposition image is generated in which the vehicle is depicted located at the first position at the first point in time and at the second position at the second point in time, and a model type of vehicle is determined and is stored in the traffic situation data set,
wherein the model type is determined using a vehicle database.

2. The method according to claim 1, wherein in the storage step, in the superimposition image and/or in the first image at least one first component of the vehicle from the first image is marked, and in the superimposition image and/or in the second image the first component of the vehicle from the second image is marked, in particular wherein in addition at least one second component of the vehicle from the first image and the second component of the vehicle from the second image are marked.

3. The method according to claim 1, wherein the first component and/or the second component from the first image are/is connected to the first component and/or the second component from the second image, by means of at least one line.

4. The method according to claim 1, wherein a distance between a position of the vehicle in the area surrounding the recording device in the first image and a position of the vehicle in the area surrounding the recording device in the second image is determined using the position of the first component in the first image and the position of the first component in the second image and/or using the position of the second component in the first image and the position of the second component in the second image in the area surrounding the recording device.

5. The method according to claim 4, wherein plausibility checking of the sensed speed with the determined distance between the vehicle at the first position and at the second position is carried out using the time period, of the first point in time and/or second point in time, wherein a result of the plausibility checking is added to the traffic situation data set.

6. The method according to claim 1, wherein in the first image and/or the second image an auxiliary line is added which represents a course of a vehicle component transversely with respect to the direction of travel, in particular wherein the auxiliary line depicts a profile of a bumper of the vehicle.

7. The method according to claim 1, wherein a model type of the vehicle is determined and stored in the traffic situation data set, wherein the model type is determined on the basis of a contour of the vehicle.

8. The method according to claim 1, wherein in the sensing step the speed of the vehicle is sensed using a laser system and/or lidar system, a radar system and/or a camera system and/or image sensor as a speed sensor.

9. The method according to claim 1, wherein the first image and the second image are read in from a camera the location and/or viewing direction of which are/is unchanged when the first image and the second image are captured.

10. The method according to claim 1, wherein a camera for capturing the first image and the second image is rotated through a predetermined angle after the first image has been captured, before the second image is captured, wherein in the storage step the predetermined angle is stored in the traffic situation data set.

11. The method according to claim 1, wherein in the reading-in step at least one third image is read in which depicts the vehicle at a third point in time at a third position in the area surrounding the recording device, wherein in the sensing step a speed of the vehicle is sensed in a time interval between the first, second and/or third points in time, and wherein in the storage step the third image, of the third point in time and/or a time period between the second and the third point in time, is added to the traffic situation data set in order to record the traffic situation, wherein the third point in time and/or a time period between the second and the third point in time are then added to the traffic situation data set if the third image has not been captured at a third point in time which lies after a predefined time period between the second and the third points in time.

12. A recording device which is configured to execute and/or actuate the steps of the method according to claim 1 in corresponding units.

13. A computer program which is configured to execute and/or actuate the steps of the method according to claim 1.

14. A machine-readable storage medium in which the computer program according to claim 13 is stored.
